(19) United States
(12) Patent Application Publication
(10) Pub. No.: US 2015/0001240 A1
(43) Pub. Date: Jan. 1, 2015

(54) VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YUN-LUNG CHEN, New Taipei (TW); GANG SU, Wuhan (CN); WEI-YONG MA, Wuhan (CN); REN-XI DOU, Wuhan (CN); LIANG TU, Wuhan (CN); ZHI-WU XIA, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/313,768

(22) Filed: Jun. 24, 2014

(30) Foreign Application Priority Data
Jun. 28, 2013 (CN) 2013102640417

(51) Int. Cl. G07F 11/02

(52) U.S. Cl. CPC G07F 11/02
USPC 221/92

(57) ABSTRACT

A vending machine includes a sliding way, a storage compartment, and a locking structure. The storage compartment is slidable in the sliding way. The locking structure includes a latching member and a magnetic valve. The latching member is engaged with the storage compartment, and is secured to the storage compartment. The latching member is movable relative to the storage compartment between a lock position and an unlock position. When the latching member is located in the lock position, the latching member is engaged with the sliding way, and the magnetic valve is engaged with the latching member. The latching member is disengaged from the sliding way when located in the unlocked position, and the magnetic valve is disengaged from the latching member.

### CROSS-REFERENCE TO RELATED APPLICATIONS

Relevant subject matter is disclosed in co-pending U.S. Patent Applications entitled “VENDING MACHINE”, Attorney Docket Number US52174, U.S. application Ser. No. ______, filed on ______.

### FIELD

The present disclosure generally relates to a vending machine.

### BACKGROUND

A vending machine usually includes a rack and a number of storage compartments. The storage compartments are vertically installed on the rack, for receiving a variety of products, such as snacks, beverages, alcohol, cigarettes, lottery tickets, cologne, and even gold and gems. When resupplying products, multiple storage compartments may be pulled out of the rack to be fill with new products at the same time, this cause an imbalance undesirably resulting in that the rack may topple and fall.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a vending machine.

FIG. 2 is an enlarged view of the circled portion of FIG. 1.

FIG. 3 is an exploded, isometric view of a sliding way and a top cover of FIG. 1.

FIG. 4 is a cutaway, partially assembled view of the vending machine of FIG. 1, the latching member is in a lock position.

FIG. 5 is similar to FIG. 4, and the latching member is in a unlock position.

FIG. 6 is another assembled view of the vending machine FIG. 1, and the storage compartment is pulled out of the sliding way.

### DETAILED DESCRIPTION

The disclosure is illustrated by way of example and not by way of limitation in the figures of the accompanying drawings in which like reference numerals indicate similar elements. It should be noted that references to “an” or “one” embodiment in this disclosure are not necessarily to the same embodiment, and such references mean “at least one.”

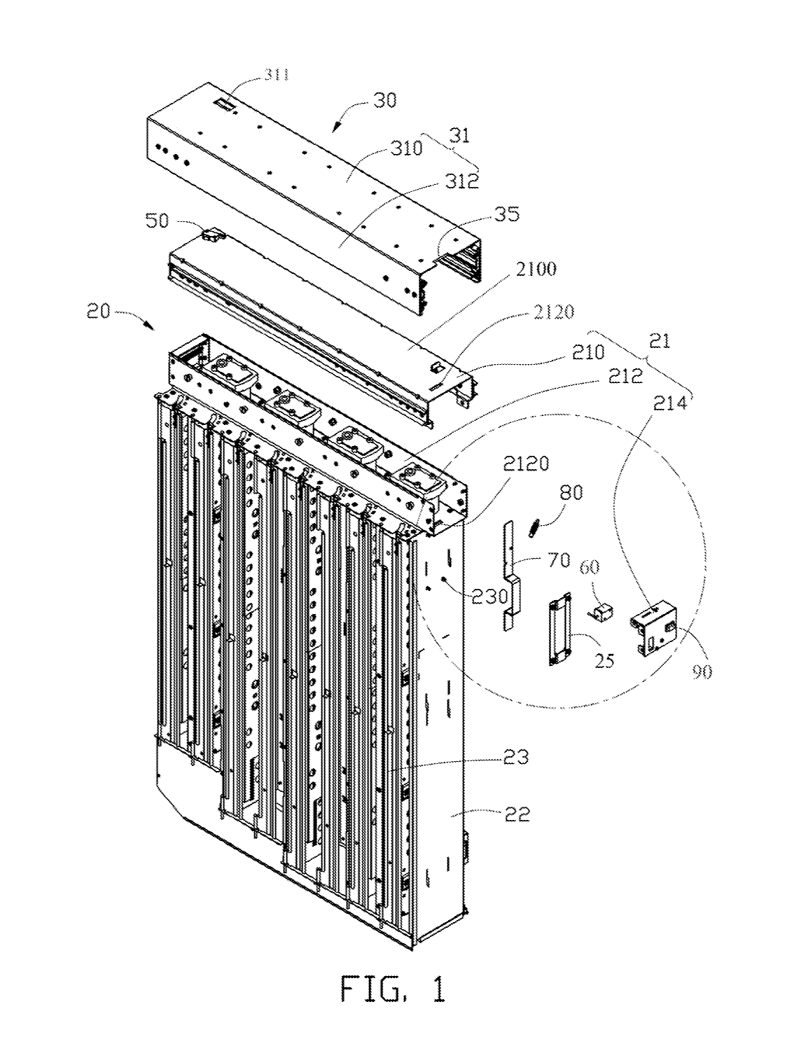

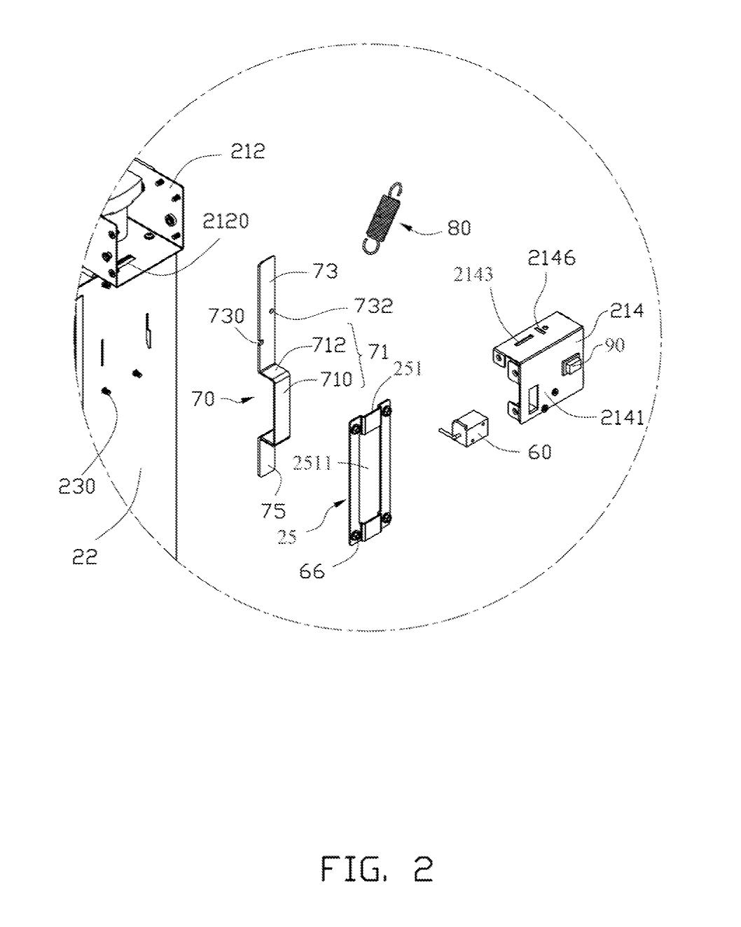

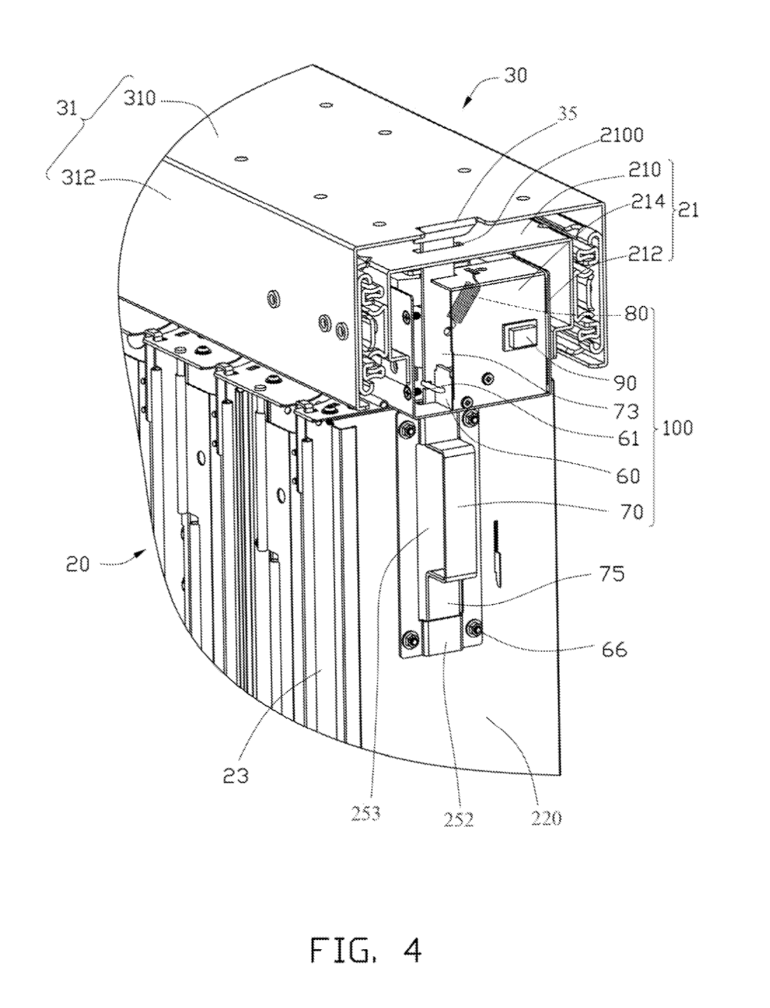

FIGS. 1 and 2 illustrate an embodiment of a vending machine. The vending machine includes a sliding way 30, a storage compartment 20 slidably engaged with the sliding way 30, and a locking structure 100 (shown in FIG. 4). The storage compartment 20 can accommodate a plurality of goods, such as snacks, beverages, alcohol, cigarettes, lottery tickets, cologne, consumer products and even gold and gems.

The storage compartment 20 includes a main body 22, a hanging portion 21 secured to the main body 22, and a pressing member 25. The main body 22 defines four channels 23 for receiving the plurality of goods. The hanging portion 21 includes a top cover 210, a bottom cover 212, and a shielding cover 214. Each of the top cover 210 and the bottom cover 212 includes a hanging plate 2100, and the hanging plate 2100 defines a through hole 2120 disposed on a front end of the hanging plate 2100. The shielding cover 214 includes a cover board 2141 and a top piece 2143 perpendicular connected to the cover board 2141. The top piece 2143 defines a first mounting hole 2146 corresponding to the locking structure 100.

The pressing member 25 can be secured to a front plate of the main body 22 and includes a first bridge portion 251, a second bridge portion 252, and two connecting pieces 253 connected to the first bridge portion 251 and the second bridge portion 252. A receiving space 2511 is formed among the first bridge portion 251, the second bridge portion 252, and the two connecting pieces 253.

The sliding way 30 includes an installation plate 310 and two side plates 312. The two side plates 312 substantially perpendicularly extend upwards from two opposite edges of the installation plate 310. A stopping tab 35 extends from a front end of the installation plate 310. The stopping tab 35 is slanted relative to the installation plate 310, and an acute angle is defined between the installation plate 310 and the stopping tab 35 or the stopping tab 35 is substantially perpendicular to the installation plate 310. An opening 311 is defined in the installation plate 310 adjacent to a rear end of the installation plate 310. A compressing piece 33 is located on an inner side of the installation plate 310 and includes a resisting tab 331 and a guiding tab 332 extending from the resisting tab 331. The resisting tab 331 extends from one edge of the opening 311 and is substantially parallel to the two side plates 312. The guiding tab 332 extends from the resisting tab 332, and an obtuse angle is defined between the guiding tab 332 and the resisting tab 331.

The locking structure 100 includes a micro-switch 50, a magnetic valve 60, a latching member 70, a resilient member 80, and a reset switch 90. The micro-switch 50 is secured to a rear end of the hanging plate 2100 of the top cover 210. A blocking pole 61 is formed in the magnetic valve 60. The blocking pole 61 can be stretched from the magnetic valve 60 when the magnetic valve 60 is powered and can be retracted into the magnetic valve 60 when the magnetic valve 60 is not powered. In one embodiment, the resilient member 80 is an extension spring.

FIG. 2 shows that the latching member 70 includes a latching piece 73, a positioning piece 75 and an operation portion 71 connected to the latching piece 73 and the positioning piece 75. The latching piece 73 defines a cutout 730 adjacent to the operation portion 71, and a second mounting hole 732 is defined in the latching piece 73, located on a top right of the cutout 730. The operation portion 71 includes two limiting pieces 712 and an operation piece 710 connected to the two limiting pieces 712. One of the two limiting pieces 712 is substantially perpendicularly connected to the latching piece 73 and the operation piece 710. Another of the two limiting pieces 712 is substantially perpendicularly connected to the operation piece 710 and the positioning piece 75.

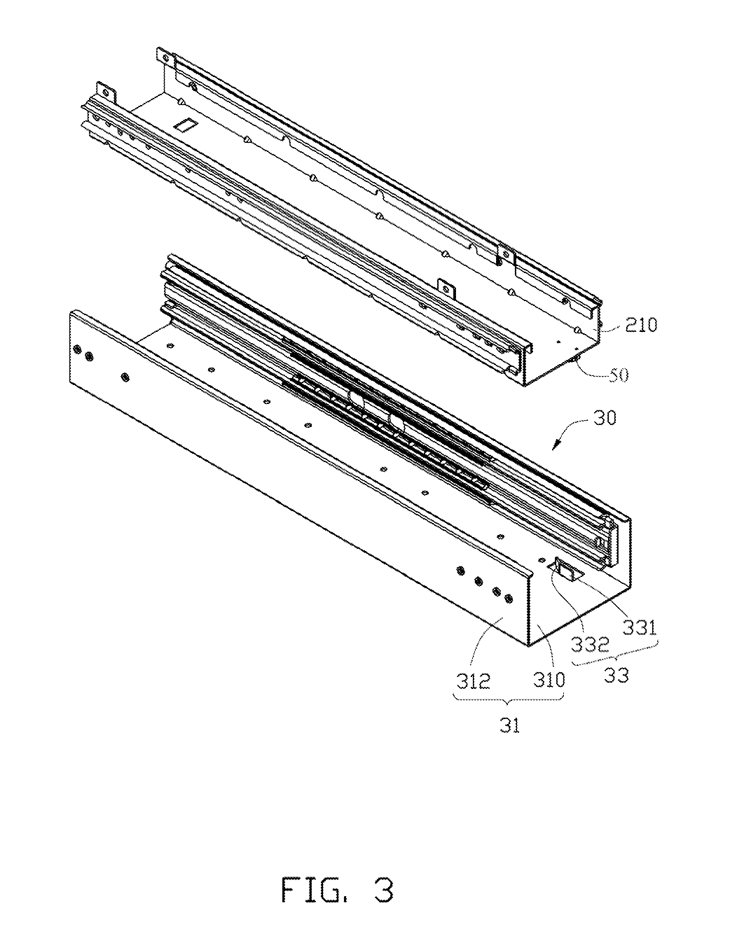

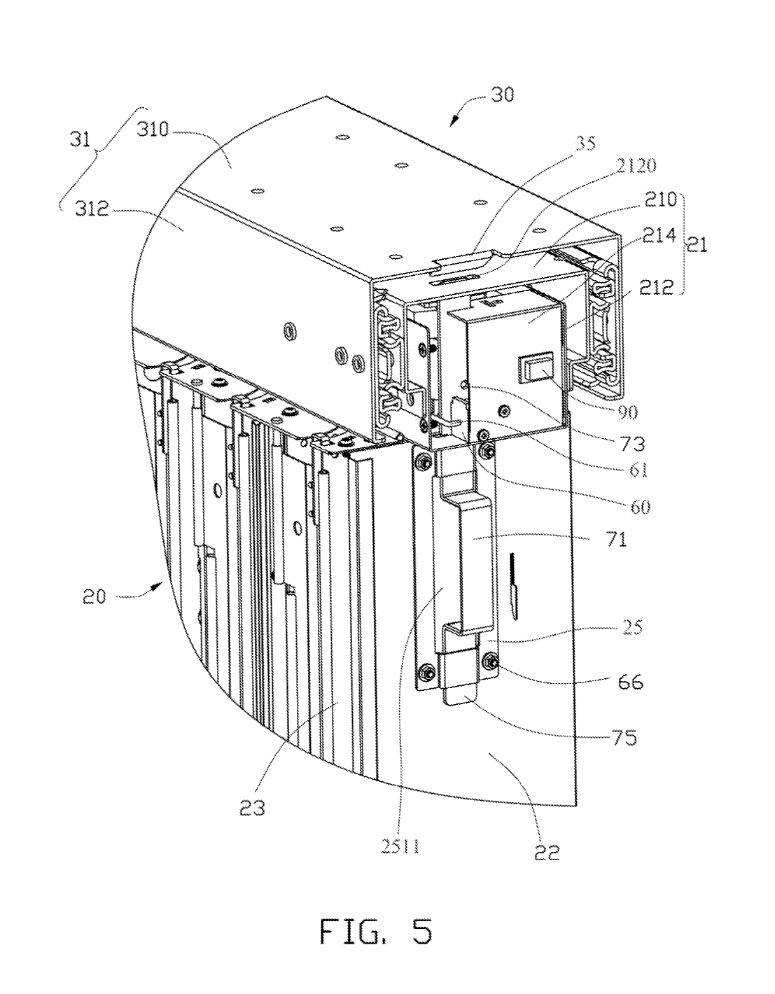

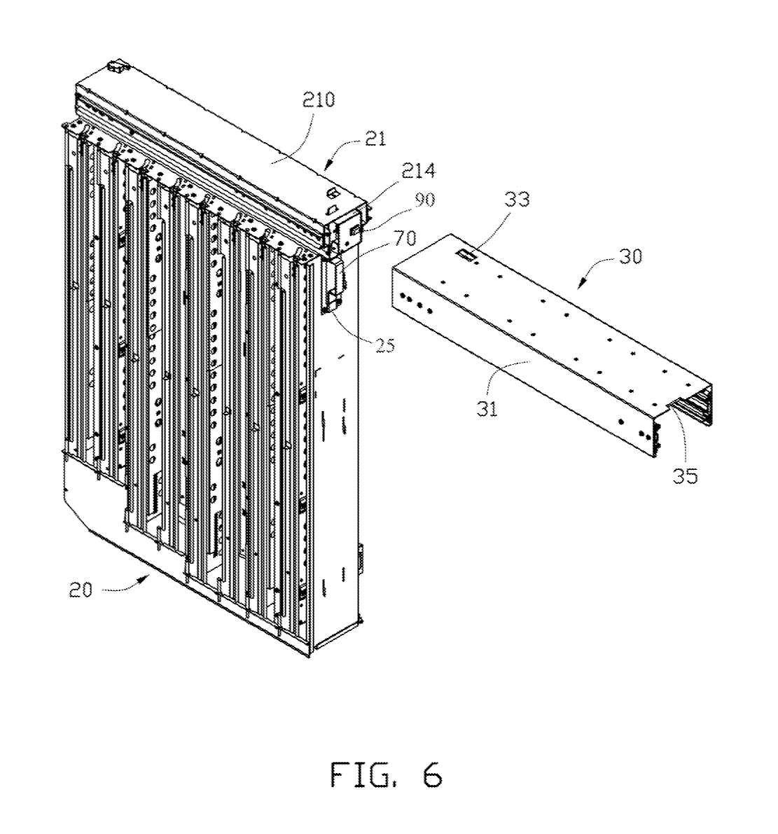

FIGS. 3-8 show that in assembly, the storage compartment 20 is suspended on the sliding way 30 by the hanging portion 21 being engaged with the sliding way 30, and the micro-switch 50 resists the compressing piece 33. The latching piece 73 extends through the through hole 2120 located on the bottom cover 212 and is aligned with the through hole 2120 located on the top cover 210. The operation portion 71 extends through the receiving space 2511, and the pressing member 25 is secured to the front plate 220 in a well known way, such as screwing 66. The latching piece 73 is positioned between the first bridge portion 251 and the front plate 220. The positioning piece 75 is located between the second bridges portion 252 and the front plate 220.

The shielding cover 214 is secured to a front end of the hanging portion 21. The magnetic valve 60 is secured to the cover board 2141 via a well known manner, such with screws. The reset switch 90 is secured to the cover board 2141, and the micro-switch 50 is secured to the rear end of the top cover 210. A first end of the resilient member 80 is engaged in the first mounting hole 2331 and a second end of the resilient member 80 is engaged in the second mounting hole 732. The latching piece 73 extends through another through hole 2120 and abuts the stopping tab 35 driven by the resilient member 80. In one embodiment, the resilient member 80 has a center axis, and an acute angle is defined between the center axis and the latching piece 73.

In use, the magnetic valve 60 is powered and is in a lock state so that the blocking pole 61 is stretched out the magnetic valve 60 and is engaged in the cutout 730, to secure the storage compartment 20 to the sliding way 30. The latching member 70 is located in a lock position, where the latching piece 73 is engaged with the stopping tab 35.

When resupplying product, the reset switch 90 is pressed to open the magnetic valve 60 stopping power and unlocking the magnetic valve 60. The blocking pole 61 is retracted into the magnetic valve 60 to disengage from the cutout 730. The latching member 70 is pulled to move along a first direction to an unlocked position, where the latching piece 73 is disengaged from the stopping tab 35.

After the storage compartment 20 is filled with goods, and is pushed into the sliding way 30. The resilient member 80 is released and resiliently rebounds to move the latching member 70 along a second direction opposite to the first direction, to engage the latching piece 73 with the stopping tab 35. The micro-switch 50 is switched on, powering the magnetic valve 60. The blocking pole 61 is stretched out of the magnetic valve 60 to be engaged in the cutout 730. The storage compartment 20 is secured to the sliding way 30.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine, comprising:
a sliding way;
a storage compartment slidably positioned in the sliding way; and
a locking structure comprising a latching member and a magnetic valve; the latching member being engaged with the storage compartment, and the magnetic valve being secured to the storage compartment;
wherein the latching member is movable relative to the storage compartment between a lock position and an unlock position; when the latching member is located in the lock position, the latching member is engaged with the sliding way, and the magnetic valve is engaged with the latching member; when the latching member is located in the unlock position, the latching member is disengaged from the sliding way, and the magnetic valve is disengaged from the latching member.

2. The vending machine of claim 1, wherein the sliding way comprises a stopping tab, the latching member comprises a latching piece defining a cutout, a blocking pole is formed on the magnetic valve; when the latching member is located in the lock position, the latching piece is engaged with the stopping tab, to prevent the storage compartment from sliding from the sliding way, and the blocking pole is engaged in the cutout; when the latching member is located in the unlock position, the latching piece is disengaged from the stopping tab, and the blocking pole is disengaged from the cutout.

3. The vending machine of claim 2, wherein the locking structure further comprises a resilient member, the storage compartment comprises a shielding cover, a first end of the resilient member is engaged with the latching piece, and a second end of the resilient member is engaged with the shielding cover.

4. The vending machine of claim 2, wherein the sliding way further comprises an installation plate, the stopping tab extends from the installation plate, and an acute angle is defined between the installation plate and the stopping tab or the stopping tab is substantially perpendicular to the installation plate.

5. The vending machine of claim 4, wherein the storage compartment further comprises a hanging portion, the hanging portion is engaged with the sliding way, and the shielding cover is secured to the hanging portion and covers the hanging portion.

6. The vending machine of claim 5, wherein the hanging portion defines two through holes, the latching member is movable along a direction perpendicular to the installation plate to extend through the two through holes to be engaged with the stopping tab.

7. The vending machine of claim 4, wherein the latching piece is substantially perpendicular to the installation plate.

8. The vending machine of claim 4, wherein the storage compartment further comprises a main body and a pressing member attached to the main body, and the latching member is movably engaged between the main body and the pressing member.

9. The vending machine of claim 8, wherein the latching member further comprises a positioning piece, the pressing member comprises a first bridge portion and a second bridge portion, the latching piece is engaged between the first bridge portion and the main body, and the positioning piece is engaged between the second bridge portion and the main body.

10. The vending machine of claim 9, wherein the latching member further comprises an operation portion connected to the latching piece and the positioning piece, the pressing member further comprises two connecting pieces connected to the first bridge portion and the second bridge portion, the first bridge portion, the second bridge portion, and the two connecting pieces cooperatively define a receiving space, and the operation portion is engaged in the receiving space.

11. A vending machine, comprising:
a sliding way comprising an installation plate and a stopping tab, the stopping tab extending from the installation plate;
a storage compartment being slidably installed in the sliding way; and
a locking structure comprising a latching member and a magnetic valve; the latching member being engaged with the storage compartment, and the magnetic valve being secured to the storage compartment;
wherein the latching member is engaged with the stopping tab when the magnetic valve is engaged with the latching member; and the latching member is movable relative to the storage compartment along a first direction perpendicular to the installation plate, to disengage from the stopping tab when the magnetic valve is disengaged from the latching member.

12. The vending machine of claim 11, wherein the latching member comprises a latching piece defining a cutout, a blocking pole is formed on the magnetic valve; the latching piece is engaged with the stopping tab when the blocking pole is engaged in the cutout; and the latching piece is movable to disengage from the stopping tab when the blocking pole is disengaged from the cutout.

13. The vending machine of claim 12, wherein the locking structure further comprises a resilient member, the storage compartment comprises a shielding cover, a first end of the resilient member is engaged with the latching piece, and a second end of the resilient member is engaged with the shielding cover.

14. The vending machine of claim 13, wherein the resilient member has a center axis, and an acute angle is defined between the center axis and the latching piece.

15. The vending machine of claim 11, wherein an acute angle is defined between the installation plate and the stopping tab or the stopping tab is substantially perpendicular to the installation plate.

16. The vending machine of claim 11, wherein the storage compartment further comprises a hanging portion, the hanging portion is engaged with the sliding way, and the shielding cover is secured to the hanging portion and covers the hanging portion.

17. The vending machine of claim 16, wherein the hanging portion defines two through holes, the latching member is movable along a second direction opposite to the first direction to extend through the two through holes to be engaged with the stopping tab.

18. The vending machine of claim 12, wherein the latching piece is substantially perpendicular to the installation plate.

19. The vending machine of claim 12, wherein the storage compartments further comprises a main body and a pressing member attached to the main body, and the latching member is movably engaged between the main body and the pressing member.

20. The vending machine of claim 19, wherein the latching member further comprises a positioning piece, the pressing member comprises a first bridge portion and a second bridge portion, the latching piece is engaged between the first bridge portion and the main body, and the positioning piece is engaged between the second bridge portion and the main body.
